(19) United States
(12) Patent Application Publication
(10) Pub. No.: US 2016/0082317 A1
(43) Pub. Date: Mar. 24, 2016

(54) WIRELESS FITNESS TRACKING AND FITNESS ANALYSIS SYSTEM

(71) Applicant: Kevin Vincent Doherty

(72) Inventor: Kevin Vincent Doherty, Brewster, NY (US)

(21) Appl. No.: 14/864,678

(22) Filed: Sep. 24, 2015

Related U.S. Application Data
(60) Provisional application No. 62/054,435, filed on Sep. 24, 2014.

(51) Int. Cl. A63B 24/00; H04W 4/02

(52) U.S. Cl. CPC A63B 24/0062; H04W 4/02; A63B 24/0059

(57) ABSTRACT

A system and method for tracking activity, such as individual or group workouts, or fitness programs. In embodiments, one or more wireless communication sensors or beacons are in wireless communication with a mobile computing device that is configured to receive data and determine a user's engagement with the sensor. Recording and reporting of data is provided in formats that and viewable or shareable.

### PRIORITY CLAIM

This application claims priority to U.S. Patent Application No. 62/054,435, filed Sep. 24, 2015 and titled, “WIRELESS FITNESS TRACKING AND FITNESS ANALYSIS SYSTEM,” the contents of which is incorporated by reference in its entirety.

### BACKGROUND

Individuals exercising at fitness facilities typically bring with them, and use during their workout, wireless communication devices including, but not limited to, mobile phones, MP3 players, smartwatches, tablets, personal digital assistants (PDA's), etc. These devices are typically used to stay in contact with the outside world, playing music, listening to audiobooks, getting fitness routine assistance, and making phone calls.

When completing a workout, a user may have exposure to electronic fitness equipment (treadmill, elliptical, etc.) and/or non-electrical fitness equipment (free-weights, weighted plates, kettle bells, yoga mats, pull up bars, dumbbells, etc.). For the electronic equipment, feedback that is often useful for tracking progress and developing future fitness routines, in the form of distance covered, repetitions, resistance, etc., and this information may be displayed to the user. With regard to the non-electrical equipment, information viewable to the user may be limited to weight/resistance used, equipment settings, seat settings, etc. Information from both the electronic and non-electronic equipment is often not recorded physically and/or electronically for future reference and left to the user to track on their own, often times done with pen and paper. Our fitness analysis system, through a number of methods, would have the ability to capture, save (at least a subset of this information) and/or display, via a user interface, a number of variables, including but not limited to, distance ran, speed, steps taken, altitude climbed, pace, repetitions, revolutions, sets, intensity level (weights utilized in a given exercise, resistance, etc.), exercise completed, fitness equipment used (barbell, dumbbell, bench press machine, elliptical, treadmill, etc.), duration of fitness routine, duration a specific piece of fitness equipment was used for, fitness facility a user is currently utilizing, where in a specific fitness facility a user is located, suggested fitness routines, etc. Our system may also receive, and/or incorporate information and/or utilize data from wireless health and fitness tracking devices, including, but not limited to, pedometers, heart rate monitors, blood glucose, etc.

In the discussion that follows, details relating to wireless devices and networks are assumed to be known to those skilled in the art. Accordingly, such details are largely omitted herein for the sake of clarity and explanation. In addition, any references herein to an example embodiment involving a cellular telephone is solely for purposes of explanation, and is not intended to limit the invention to any such embodiment. For example, a wireless device as contemplated by various embodiments of the invention may include, but are not limited to: cellular telephones, personal digital assistants (PDA's), MP3 players, email devices, smartwatches, tablets, and the like. The wireless device may operate in a cellular, SMR, PCS, cordless, unlicensed AWS, 700 MHz, and/or other spectrums. Furthermore, embodiments are not limited by the network servicing the device. Accordingly, embodiments may be applicable to any network type including, for example, TDMA, CDMA, EV-DO, HSDPA/HSUPA, WCDMA, GSM, Wi-Fi, WiMax, OFDM, UMTS, Bluetooth, Bluetooth Low Energy, and other standards now known and/or to be developed in the future.

### BRIEF DESCRIPTION OF THE DRAWINGS

FIG. 1 is one embodiment of the system wherein a wireless communication device is placed on a fitness facility's exterior and another wireless communication device is placed near the fitness facilities exterior. In this embodiment the user's wireless communication device would receive a wireless communication when it enters a given proximity surrounding any and/or multiple and/or all wireless communication devices. Entering this proximity may trigger the fitness analysis system to take an action and/or update the database and/or update the information in memory and/or update the user interface.

FIG. 2 is one embodiment which could be separate or in addition to the embodiment in FIG. 1. The embodiment displayed in FIG. 2 includes wireless communication devices placed in various areas within the fitness facility (the pool, the free weight area, the studio, etc). In this embodiment the user's wireless communication device would receive a wireless communication when it enters a given proximity surrounding any and/or multiple and/or all wireless communication devices. Entering this proximity may trigger the fitness analysis system to take an action and/or update the database and/or update the information in memory and/or update the user interface.

FIG. 3 is one embodiment which could be separate or in addition to the embodiment in FIG. 1 and/or the embodiment in FIG. 2. The embodiment displayed in FIG. 3 includes a wireless communication device placed on a piece of fitness equipment. In this embodiment the user's wireless communication device would receive a wireless communication when it enters a given proximity surrounding the wireless communication device. The system may also receive information regarding the movement of the fitness equipment and/or portion of the fitness equipment should the wireless communication device also contain and accelerometer and/or altimeter. Entering this proximity may trigger the fitness analysis system to take an action and/or update the database and/or update the information in memory and/or update the user interface.

FIG. 4 is one embodiment which could be separate or in addition to the embodiment in FIG. 1 and/or the embodiment in FIG. 2 and/or the embodiment in FIG. 3. The embodiment displayed in FIG. 4 includes a wireless communication device placed on a weighted plate. In this embodiment the user's wireless communication device would receive a wireless communication when it enters a given proximity surrounding the wireless communication device. The system may also receive information regarding the movement of the weighted plate should the wireless communication device also contain and accelerometer and/or altimeter. Entering this proximity may trigger the fitness analysis system to take an action and/or update the database and/or update the information in memory and/or update the user interface.

FIG. 5 is one embodiment which could be separate or in addition to the embodiment in FIG. 1 and/or the embodiment in FIG. 2 and/or the embodiment in FIG. 3 and/or the embodiment in FIG. 4. This embodiment shows a user with a wireless communication device receiving information from five different sources—a wireless communication device located near the fitness facilities exterior, a wireless communication device placed within a certain area of the fitness facility, a wireless communication device placed on a piece of fitness equipment, a wireless communication device placed on a weighted plate, and a wireless communication device placed near the fitness facilities reception area and/or entrance. In this embodiment the user's wireless communication device would receive a wireless communication when it enters a given proximity surrounding a single wireless communication device and/or multiple wireless communication devices and/or all of the wireless communication devices. The system may also receive information regarding the movement of the fitness equipment and/or a portion of the fitness equipment and/or the weighted plate should the wireless communication device also contain an accelerometer and/or altimeter. Entering any and/or some and/or all of the proximities may trigger the fitness analysis system to take an action and/or update the database and/or update the information in memory and/or update the user interface.

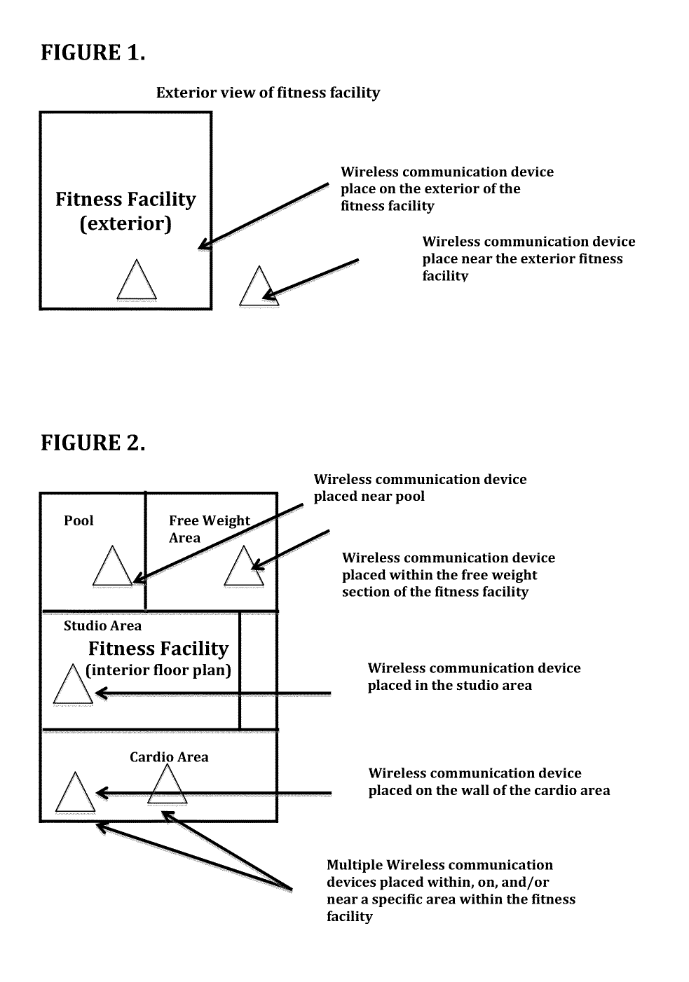

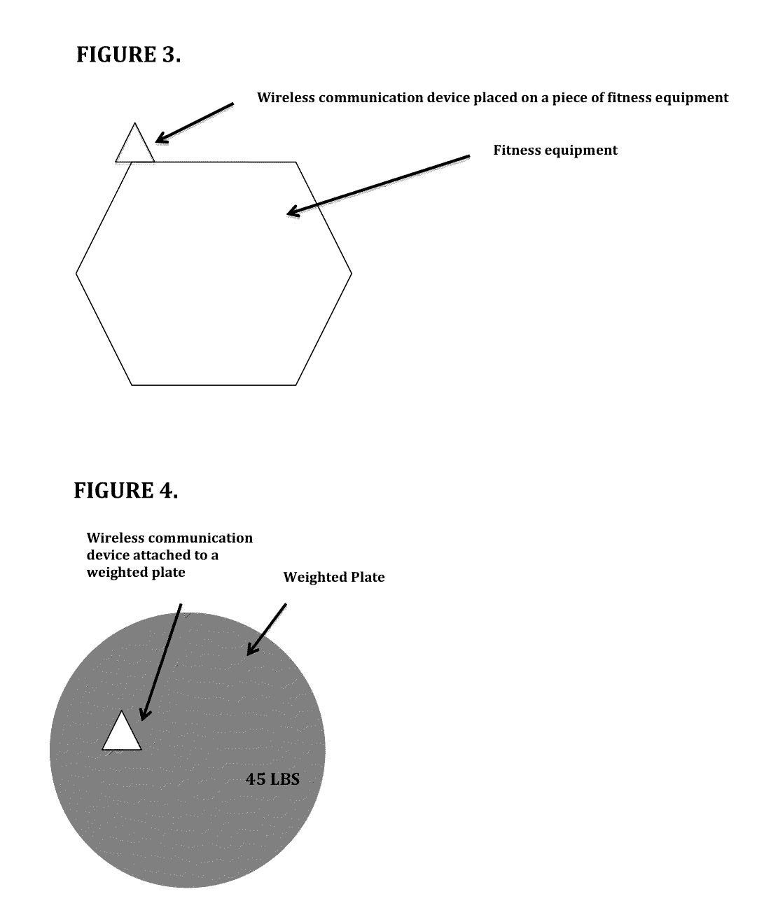

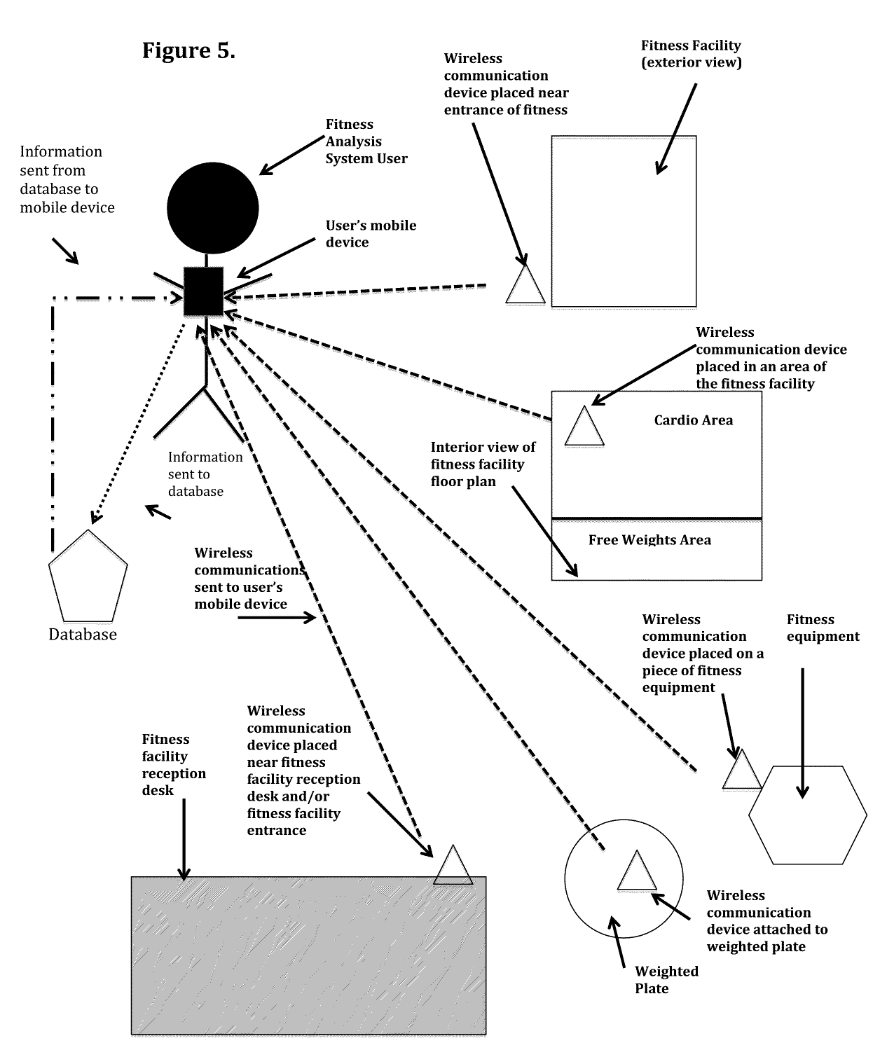

### SUMMARY

In some embodiments, a system for tracking and quantifying activity may include a group of wireless communication devices, application software running on the mobile computing device configured to receive information from the wireless communication devices and store the information in a database, and/or a database containing a list of known wireless communication devices correlating to the type of object to which each wireless communication device is attached. In some embodiments, the wireless communication devices are each (i) attached to an object and (ii) configured to transmit a data signal that may be received by a mobile computing device. In some embodiments, the output of the database is used to calculate at least one metric concerning a user's engagement with one of the wireless communication devices. In some embodiments, the application software is further configured to enable the user to share the at least one metric with other users. In some embodiments, the data signal may include the proximity of one of the wireless communication devices to a mobile computing device. In some embodiments, the data signal may include the orientation of one of the wireless communication devices. In some embodiments, the object is a unit of fitness equipment. In some embodiments, the at least one metric may include one of duration, type, and number of repetitions.

In some embodiments, the application software interacts with the wireless communication devices according to a schedule, whereby the schedule is based upon the time of day, or the pattern of the user's prior interactions with the mobile computing device. In some embodiments, the application software is further configured to provide incentives to the user for engagement with the system. In some embodiments, a method of tracking and quantifying activity may include receiving, on a mobile computing device, a group of signals from a wireless communication device attached to an object; using the data to reference a database of known wireless communication devices and identify the object to which the wireless communication device is attached; and/or calculating at least one metric concerning a user's engagement with one of the wireless communication devices. In some embodiments, the group of signals may include data concerning a user's engagement with the wireless communication device.

In some embodiments, the data is received according to a schedule. In some embodiments, the at least one metric may include one of exercise duration, exercise type, time, number of sets, and number of repetitions. In some embodiments, the mobile computing device stores data related to a particular session. In some embodiments, the data related to a particular session may include one of workout name, workout category, workout type, workout sets, workout repetitions, and workout intensity. In some embodiments, the schedule is based upon the length of time since the last data was received. In some embodiments, the schedule is based upon the time of day or the user's prior interactions with the mobile computing device. In some embodiments, such a method may further include providing rewards or incentives to the user for engagement with the system. In some embodiments, such a method may further include enabling the user to share the at least one metric with other users. In some embodiments, the sharing step occurs in real time.

### DETAILED DESCRIPTION

Methods and systems for use in connection with a fitness routine and/or exercise apparatus and/or equipment. A system utilized for, but not limited to, tracking a fitness facility member and/or tracking their fitness routine as they move through a fitness facility and/or go about their fitness routine. Utilizing wireless communication with wireless devices in, near, and/or attached to a fitness facility and/or a specific area within a fitness facility, and/or a piece, or multiple pieces, of fitness equipment, a fitness facility member's actions and/or exercises and/or movements and/or experiences and/or fitness routine, etc. are communicated wirelessly to a user's wireless device and/or at least a subset of this information may be saved in the fitness analysis system and/or in a database and/or in memory which may run on a user's wireless communication device. At least a subset of this information, and/or the information contained in the fitness analysis system, may be saved in-memory and/or in a database. In one such method, wireless communication between a wireless device and/or the user's wireless device is established and/or a wireless communication is sent between a wireless device and a user's wireless device (cellular phone, MP3 player, personal digital device (PDA), etc.) and, via wireless communication with the aforementioned wireless device, it is determined that an individual, along with their wireless device, may have entered a fitness facility and/or entered a specific area of a fitness facility (spinning studio, free weight section of gym, cardio section of gym) and/or is currently utilizing a specific piece, and/or multiple pieces, of fitness equipment (free weight, exercise machine, treadmill, yoga mat, etc.). In this method, a wireless communication device is placed on, near, and/or inside a piece of fitness equipment and/or a specific area within the fitness facility and/or a fitness facility and wireless communication may be established between the user's wireless device and/or any/all of these wireless devices. In this method, communication between the user's wireless device and/or the fitness facility and/or the specific area of the fitness facility and/or the specific piece, or multiple pieces, of fitness equipment would be established, which may make the user's wireless device aware of where the user may be located relative to the fitness facility and/or an area within the fitness facility and/or a specific piece, or multiple pieces, of fitness equipment. This information may inform the system as to where in the fitness facility and/or what piece and/or pieces of fitness equipment a user is utilizing. The fitness analysis system may receive wireless communications from the wireless device(s) placed near, on, and/or inside the fitness equipment and/or the wireless device placed within and/or near the fitness facility and/or the wireless devices placed within and/or near specific areas within the fitness facility. The information sent to the fitness analysis system from these wireless devices may provide insight with regard to the user's fitness routine and/or this information may be used to facilitate subsequent workouts. The fitness analysis system, which may be aware of the users' fitness goals, and/or personal statistics (height, weight, nutrition regiment, sleep regiment, previous workout routines, previous exercises completed, previous exercises completed using the wireless tracking, user's location, etc.) may continuously receive wireless communications from the fitness equipment and/or the fitness facility and/or the specific area of the fitness facility and this information may be used to update information in the fitness analysis system and/or the user interface on the user's wireless device and/or the information contained in the database and/or the information contained in-memory. These updates to the fitness analysis system can take place prior to, during, and/or after the user has entered the fitness facility and/or the specific area within the fitness facility and/or has engaged with a piece, or multiple pieces, of fitness equipment and/or the user has completed their fitness routine. The information received by the user's wireless device from these wireless devices over the course of the user's fitness routine (equipment name, area within fitness facility, duration, intensity, settings, etc.) may be utilized to facilitate subsequent fitness routines prior to, during, and/or after a fitness routine has been completed. In another method, when the user leaves the fitness area, the fitness analysis system may be updated. When the user leaves the fitness facility and/or moves beyond a certain proximity from a wireless communication device, the fitness analysis system may receive a wireless communication notifying the system that the user has left the facility and/or moved beyond a certain distance and/or the fitness routine may be concluded and/or the appropriate actions in the fitness analysis system may be triggered via wireless communication. The user has the ability to view at least a subset of their, and/or the other users' information in the fitness analysis system and/or the user may have the ability to share their personal statistics and/or their fitness routine information with other users and/or third-parties. This information may be viewed and/or shared prior to, during, and/or after the fitness routine has completed. The user may also choose to share their personal statistics and/or their fitness routine information with third parties.

In view of the limitations outlined, methods, and wireless devices for use in connection with a fitness routine and fitness equipment is disclosed herein. The subject matter of the disclosed embodiments is described with specificity to meet statutory requirements. However, the description itself is not intended to limit the scope of this patent. Rather, the inventor has contemplated that the claimed subject matter might also be embodied in other ways, to include different steps and/or elements similar to the ones described in this document, in conjunction with other present and/or future technologies. Moreover, although the term “step” may be used herein to connote different aspects of methods employed, the term should not be interpreted as implying any particular order among or between various steps herein disclosed unless and except when the order of individual steps is explicitly described. The embodiments disclosed herein allow a person to use a wireless device in connection with a fitness routine and/or fitness equipment.

### Embodiment 1

In one embodiment, a wireless communication may be sent from a wireless communication device located inside, near, and/or attached to a fitness facility and/or within a specific area of the fitness facility and/or a piece, and/or multiple pieces, of fitness equipment to a user's wireless device when that user has entered and/or exited a fitness facility and/or a specific area of the fitness facility (cycling studio, yoga studio, basketball court, tennis court, pool, free-weight section of a fitness facility, spinning studio, dance studio, etc.) and/or utilized a piece, and/or multiple pieces, of fitness equipment (including, but not limited to exercise equipment, dumbbells, weighted plates, etc). The wireless communication devices may have installed within their housing, and/or have available to them, an accelerometer and/or an altimeter and/or a thermometer. This wireless communication may include information including, but not limited to the user's location from a given wireless communication device, the fitness equipment's name, the fitness equipment's description, the speed at which the user and/or the fitness equipment is traveling, the time the wireless communication was sent, the battery level of the wireless communication device, the radius being monitored, and the height of the wireless communication device. A method may recognize that a user and/or the user's wireless communication device has entered and/or exited a fitness facility and/or a specific area of the fitness facility and/or is utilizing a piece, and/or multiple pieces, of fitness equipment when that user and/or user's wireless device comes within a certain proximity (distance may vary on a case by case matter) of a wireless communication device(s) located within and/or near and/or attached to that fitness facility and/or a specific area within the fitness facility and/or a piece of fitness equipment. This communication may update the user's wireless device and/or the fitness analysis system and/or the user interface and/or the fitness facilities existing hardware and/or software as to the user's location within the fitness facility and/or within a specific area within the fitness facility and/or relative to a piece, and/or multiple pieces, of fitness equipment. The fitness equipment, via a wireless communication device attached to and/or near and/or inside the fitness equipment, may notify the user's wireless device and/or the fitness analysis system and/or the user interface and/or the fitness facilities software and/or hardware, via a wireless communication, as to which piece, and/or multiple pieces, of fitness equipment a user may currently be utilizing and/or has previously utilized and/or intends to use subsequently (a method may determine the proximity of a fitness facility and/or a specific area within a fitness facility and/or a piece of fitness equipment to the user's wireless device—this method is not the only manner and/or method in which a user's location and/or actions and/or fitness routine can be calculated and other methods may be applicable). One method may determine that a user has entered and/or exited a fitness facility based on the user's distance, as measured by their wireless device, from a wireless communication device placed on, near and/or within the fitness facility and/or a specific area within the fitness facility and/or a specific piece, or multiple pieces, of fitness equipment (this method is not the only manner and/or method in which distance and/or exit/entry can be calculated). Each fitness facility and/or specific area within a fitness facility and/or piece of fitness equipment may receive its own unique identifier and based on the unique identifier of facility and/or the specific area within the facility and/or the piece, and/or multiple pieces of fitness equipment (multiple pieces of fitness equipment may each receive their own unique identifier), a method may determine where in the facility the user may be and/or what specific equipment the user is utilizing and/or determine, via a method, additional information regarding the users fitness routine (this method is not the only method in which a user's location and/or a user's fitness routine and/or actions can be determined and other methods may be applicable). The method may also be able to determine the name of the previously performed and/or currently performing and/or to be performed in the future exercise, and/or the intensity of the user's exercise (how much resistance/weight the user utilized for a particular exercise) and/or the duration of the exercise and/or fitness routine (the duration of that specific exercise, the repetitions completed by the user, the sets completed by the user, and/or the total time in the fitness facility, etc.). Additional information regarding the user and/or the user's fitness routine which may be collected by the system and/or stored in the database and/or used to update the interface, include, but are not limited to, steps the user has taken, distance ran, pace, route map, distance traveled, temperature, and/or flights of stairs and/or altitude climbed. This information may be updated at certain time intervals throughout the user's fitness routine and/or as the user progresses with their fitness routine and/or with each different exercise a user completes while completing the fitness routine. These updates may continue until the wireless device and/or the fitness analysis system receive a wireless message from a wireless communication device within the fitness facility that may notify the user's wireless device and/or the fitness analysis system that the user has left the fitness facility and/or that specific area of the fitness facility and/or has moved away from a piece, and/or multiple pieces, of fitness equipment and/or has moved beyond a certain distance from the fitness facility. The fitness analysis system may also be updated as the user moves within the fitness facility and/or utilizes different areas of the fitness facility and/or utilizes different pieces of fitness equipment. Based on the proximity of the user's wireless communication device to wireless communication devices placed on, near and/or within the fitness facility and/or a specific area within the fitness facility and/or specific pieces of fitness equipment, we may be able to determine, via a method, what exercises and/or fitness routines a user is completing. At least a subset of this fitness information may be stored in-memory and/or in a database and/or on the fitness facilities existing software and/or may be available to the user before and/or during and/or after their fitness routine and/or may be utilized for planning future routines and/or evaluating progress toward a specific fitness goal. The user may also use their wireless device, including, but not limited to, mobile phone, a personal computer, tablet, etc., to access other information on the system (sample fitness routines, advice, etc.) and/or use the information before, during, and/or after the fitness routine. The fitness information may include, but is not limited to, other users' fitness routines, fitness routine suggestions, exercise instructions, and/or member forums and/or discussion threads. The user may also input information (weight, height, fitness routine goals, specific exercises to be completed, etc.) into the fitness analysis system and/or review fitness information (suggested fitness routines, weight loss goals, etc.) in fitness analysis system before and/or during and/or after their fitness routine. In certain circumstances, information may also be visible by, and/or shareable with, other users of the fitness analysis system, including but not limited to, other users of the fitness analysis system and/or fitness center personnel. The user may also choose to share their personal statistics and/or their fitness routine information with third parties.

### Embodiment 2

In another embodiment, wireless communication devices are attached to, near, and/or within a fitness facility and the user's wireless device may be notified of the user's entry into and/or exit from the fitness facility and/or their entry into and/or the exit from a specific area within the fitness facility. The user's wireless device may continue to receive updates (via wireless communication) as the user moves through the fitness facility before, during, and/or after their fitness routine. Once the user has moved out of a specific area and/or moved away from a specific piece, and/or multiple pieces, of fitness equipment and/or has left the fitness center entirely, the fitness analysis system and/or the user's wireless device may receive a wireless communication, from a wireless communication device within the fitness facility and/or within a specific area of the fitness facility and/or a wireless communication device attached to, located near, and/or inside a specific piece, and/or multiple pieces, of fitness equipment, notifying the system, and/or the user's wireless device and/or the fitness facility's existing hardware and/or software, of the change in user's location. At least a subset of this information would be used to update the interface and/or may be captured in the user's wireless device(s)'s memory and/or in a database. At least a subset of this fitness information may be stored in-memory and/or in the database and/or in the fitness facility's existing software and/or hardware and may be available to the user before, during, and/or after their fitness routine and/or may be utilized for planning future routines and/or evaluating progress toward a specific fitness goal. These updates may continue until the wireless device and/or the fitness analysis system receives a wireless message from a wireless communication device within and/or near and/or attached to the fitness facility and/or a specific area of the fitness facility notifying the user's wireless device and/or the fitness analysis system that the user has left the fitness facility and/or a specific area of the fitness facility entirely. The user may also use their wireless device, including but not limited to a mobile phone, personal computer, tablet, smartwatch, etc., to access fitness information associated with their, and/or other user's, fitness routines and/or use the information before and/or during and/or after the fitness routine. This information may be available to the user via a user interface on their wireless communication device, including, but not limited to, mobile phone, tablet, personal computer, another user's wireless device, etc. The fitness information can include, but is not limited to, other users' workouts and/or fitness routine suggestions and/or forum information and/or discussions. The user may also input information (weight, height, fitness routine goals, specific exercises to be completed, etc.) into the fitness analysis system and/or review fitness information (suggested fitness routines, weight loss goals, etc.) in fitness analysis system before, during, and/or after the workout. In certain circumstances information may also be visible by, and/or shareable with, other users of the fitness analysis system, including but not limited to, other users of the fitness analysis system and/or fitness center personnel. The user may also choose to share their personal statistics and/or their fitness routine information with third parties.

### Embodiment 3

In one embodiment, the system may be implemented and utilized in the following manner. The user may have a fitness analysis system in the form of a mobile device application that is saved and/or downloaded to their wireless communication device, and/or a web application accessible via the Internet. The user's wireless communication device may have access to Bluetooth and/or Bluetooth low energy capabilities. This wireless device includes a memory store that stores a portion and/or all of the fitness information related to a users fitness routine, personal statistics, other user's information (this represents a portion of the information that could be captured and is not intended to limit the scope in any way). The information saved on this device includes, but is not limited to, the unique identifier information associated with the fitness equipment used during the fitness routine. Information that can also be saved in this device's memory includes, but is not limited to, fitness routine duration (how long the user was using this specific piece of equipment for, repetitions, etc) and/or intensity level (resistance and/or weight applied to the equipment utilized, fitness equipment settings). This wireless device includes a user interface module that permits user interaction with the wireless device. The fitness center may have Bluetooth and/or Bluetooth low energy wireless communication devices installed in various areas within their facility and/or attached to, placed near, and/or placed inside certain and/or all pieces of fitness equipment (yoga mat, dumbbell, barbell, elliptical machine, treadmill, etc.) These wireless communication devices and the fitness analysis system may work independently and/or in conjunction with the software and/or hardware that the fitness facility currently utilizes and/or may utilize in the future. The wireless communication devices placed in, within, and/or near the fitness facility contain at least one identifier that may be unique to each wireless communication device and/or a group of wireless communication devices. The fitness analysis systems understands a user is utilizing a fitness center and/or a specific area within a fitness facility and/or a specific piece, and/or multiple pieces, of fitness equipment based on a wireless signal sent to the fitness analysis system from a wireless device located on, near, and/or within a fitness facility and/or a specific area within the fitness facility and/or a specific piece, and/or specific pieces, of fitness equipment. The system may understand which fitness facility and/or area of a fitness facility and/or piece, or pieces of, fitness equipment a user is utilizing based on their proximity to a wireless communication device. Once a user has moved beyond the bounds and/or proximity of a wireless communication device on, near, and/or within a fitness facility and/or a specific area within a fitness facility and/or a piece(s) of fitness equipment, the system may understand that the user is currently not utilizing this fitness facility and/or specific area within a fitness facility and/or piece(s) of fitness equipment and the fitness analysis system and/or the database and/or the memory and/or the fitness facilities existing hardware and/or software and/or the user interface may be updated. The bounds associated with the wireless devices utilized may vary. The fitness analysis system may be updated as deemed necessary. The user may also use their wireless device, including but not limited to a mobile phone, personal computer, smartwatch, tablet, etc., to access fitness information and/or use the information before, during, and/or after the workout. The fitness information can include, but is not limited to, other user's workouts, fitness routine suggestions, and/or forum information and/or discussions. At least a subset of this fitness information may be stored in-memory and/or in the database and/or with the fitness facility's existing software and/or hardware and may be available to the user before, during, and/or after their fitness routine and/or may be utilized for planning future routines and/or evaluating progress toward their specific fitness goal. The user may also input information (weight, height, fitness routine goals, specific exercises to be completed, etc.) into the fitness analysis system and/or review fitness information (suggested fitness routines, weight loss goals, etc.) in the fitness analysis system before, during, and/or after the workout. In certain circumstances information may also be visible by, and/or shareable with, other users of the fitness analysis system, including but not limited to, other users of the fitness analysis system and/or fitness center personnel. The user may also choose to share their personal statistics and/or their fitness routine information with third parties.

### Embodiment 4

In another embodiment, the user's wireless device may be notified via wireless communication of the user's entry into the fitness facility and/or their entry into a specific area within the fitness facility and/or the user's use of a piece, and/or multiple pieces, of fitness equipment. The system may work in with and/or in parallel and/or in place of the fitness facility' existing software and/or hardware. It may also work with future hardware and/or software utilized by the fitness facility. The user's wireless device may continue to receive wireless communication messages updating the system as the user moves through the fitness facility before, during, and/or after their fitness routine. Upon entering the fitness facility, a user may receive a wireless communication from a wireless communication device placed within and/or near the fitness facility and/or a wireless communication device within a specific area of this fitness facility and/or a wireless communication device placed on, near, and/or within a piece, or multiple pieces, of fitness equipment, and the user may automatically get checked-in to the fitness center using the fitness center's existing check-in system and/or the user may be checked-in via our system (we use “check-in” to mean that the user has entered the gym and/or the system—our system or the facility's existing software and/or hardware—understands that the user may currently be on the fitness center premises). Once the specific message from the wireless communication device within the fitness facility sends a message to the user's wireless communication device, the fitness analysis system may be notified that this user is in the fitness facility. If needed, a similar message may be sent to the fitness center's existing software and/or hardware system—including, but not limited to the system(s) used for keeping track of members and/or member attendance and/or check-ins at the fitness facility. Once the user has moved out of a specific area and/or moved away from a specific piece of fitness equipment and/or has left the fitness center entirely, the fitness analysis system and/or the user's wireless device may receive a wireless communication from a wireless communication device within the fitness facility and/or within a specific area of the fitness facility and/or a wireless communication device attached to, located near, and/or inside a specific piece, or multiple pieces, of fitness equipment, notifying the system of the change in the user's location. At least a subset of this information would be captured in the user's wireless device's memory and/or in a database and/or in the fitness facility's existing software and/or hardware systems. At least a subset of this stored fitness information may be available to a user before, during, and/or after their fitness routine and/or, among other things, may be utilized for planning future routines and/or evaluating progress toward a specific fitness goal. This information may also be updated in the user interface. These updates may continue until the fitness analysis system receives a wireless communication from a wireless communication device within the fitness facility notifying the user's wireless device and/or the fitness analysis system that the user has moved beyond a certain bounds and/or proximity and/or has likely left the fitness facility entirely. The fitness analysis system may also be updated as the user moves within the gym, utilizing different areas of the fitness facility and/or as the user utilizes different pieces of fitness equipment. The user may also use their wireless device, including but not limited to a mobile phone, personal computer, tablet, etc., to access fitness information and/or use the information before, during, and/or after their fitness routine. The fitness information can include, but is not limited to, other user's workouts, fitness routine suggestions, and/or forum information and/or discussions. At least a subset of this fitness information may be stored in-memory and/or in the database and/or may be available to the user before, during, and/or after their fitness routine and/or may be utilized for planning future routines and/or evaluating progress toward their specific fitness goal. The user may also input information (weight, height, fitness routine goals, specific exercises to be completed, etc.) into the fitness analysis system and/or review fitness information (suggested fitness routines, weight loss goals, etc.) in fitness analysis system before, during, and/or after the workout. In certain circumstances information may also be visible by, and/or shareable with, other users of the fitness analysis system, including but not limited to, other users of the fitness analysis system and/or fitness center personnel. The user may also choose to share their personal statistics and/or their fitness routine information with third parties.

It will be understood that there are numerous modifications of the illustrated embodiments described above which will be readily apparent to one skilled in the art, and other combinations of features disclosed herein that are individually disclosed or claimed herein, explicitly including additional combinations of such features. These modifications and/or combinations fall within the art to which this invention relates and are intended to be within the scope of the claims, which follow. It is noted, as is conventional, the use of a singular element in a claim is intended to cover one or more of such an element.

We claim:

1. A system for tracking and quantifying activity comprising:
a plurality of wireless communication devices, wherein said wireless communication devices are each (i) attached to an object and (ii) configured to transmit a data signal that may be received by a mobile computing device;
application software running on said mobile computing device configured to receive information from said wireless communication devices and store said information in a database; and
a database containing a list of known wireless communication devices correlating to the type of object to which each wireless communication device is attached.

2. The system of claim 1 wherein the output of said database is used to calculate at least one metric concerning a user's engagement with one of said wireless communication devices.

3. The system of claim 2 wherein said application software is further configured to enable the user to share said at least one metric with other users.

4. The system of claim 1 wherein said data signal comprises the proximity of one of said wireless communication devices to a mobile computing device.

5. The system of claim 1 wherein said data signal comprises the orientation of one of said wireless communication devices.

6. The system of claim 1 wherein said object is a unit of fitness equipment.

7. The system of claim 1 wherein said at least one metric comprises one of duration, type, and number of repetitions.

8. The system of claim 1 wherein said application software interacts with said wireless communication devices according to a schedule.

9. The system of claim 8 wherein said schedule is based upon the time of day.

10. The system of claim 8 wherein said schedule is based upon the pattern of the user's prior interactions with said mobile computing device.

11. The system of claim 1 wherein said application software is further configured to provide incentives to the user for engagement with the system.

12. The system of claim 1 wherein said data signal comprises authentication information that may be used to check the user into a facility.

13. A method of tracking and quantifying activity comprising:
receiving, on a mobile computing device, a plurality of signals from a wireless communication device attached to an object, wherein said plurality of signals comprise data concerning a user's engagement with said wireless communication device, and wherein said data is received according to a schedule;
using said data to reference a database of known wireless communication devices and identify the object to which said wireless communication device is attached; and
calculating at least one metric concerning a user's engagement with one of said wireless communication devices.

14. The method of claim 13 wherein said at least one metric comprises one of exercise duration, exercise type, time, number of sets, and number of repetitions.

15. The method of claim 13, wherein said mobile computing device stores data related to a particular session.

16. The method of claim 15 wherein said data related to a particular session comprises one of workout name, workout category, workout type, workout sets, workout repetitions, and workout intensity.

17. The method of claim 13 wherein said schedule is based upon the length of time since the last data was received.

18. The method of claim 13 wherein said schedule is based upon the time of day.

19. The method of claim 13 wherein said schedule is based upon the pattern of the user's prior interactions with said mobile computing device.

20. The method of claim 13 further comprising the step of providing rewards or incentives to the user for engagement with the system.

21. The method of claim 13 further comprising the step of enabling the user to share said at least one metric with other users.

22. The method of claim 21 wherein said sharing step occurs in real time.
